(19) United States
(12) Patent Application Publication
(10) Pub. No.: US 2010/0177167 A1
(43) Pub. Date: Jul. 15, 2010

(54) PORTABLE INTEGRATIVE STEREOSCOPIC VIDEO MULTIMEDIA DEVICE

(76) Inventor: CHAO HU, Guangzhou (CN)

Correspondence Address: G. LINK CO., LTD., 3550 BELL ROAD, MINOOKA, IL, 60447, US

(21) Appl. No.: 12/351,885

(22) Filed: Jan. 12, 2009

(51) Int. Cl. H04N 13/02; H04N 7/18

(52) U.S. Cl. 348/47; 348/143; 348/E13.074; 348/E07.085

(57) ABSTRACT

A portable integrative stereoscopic video multimedia device includes two digital camera modules, an adjusting device for adjusting an axle distance and included angle between the digital camera modules, a naked eye stereoscopic image liquid crystal display, optical projection systems, a projection control and image signal driver, sound pickups, loudspeakers, a memory, signal interfaces, a plurality of analog/digital converters, 2D/3D signal converters, a processor, a power source, process control software, and a body. Through the invention, a user may view stereoscopic images on the display or projected plane images with naked eyes. The invention has advantages of a simple structure and a vivid stereoscopic effect of the shot and viewed images. After further modification, the invention may be used for shooting, storing, and playing images, and may form a multi-functional personal electronic device with a mobile communication unit, an entertainment unit, and a projection unit.

### BACKGROUND OF THE INVENTION

1. Field of Invention

The present invention relates to a multi-functional electronic device, and more particularly to a portable integrative stereoscopic video multimedia device for personal use.

2. Related Art

When viewing an object, two eyes of a human have a stereoscopic sense, because a distance between two pupils of the human eyes is approximately 6-7 cm. When the two eyes view an object, the viewing angles of the two eyes are not completely the same. Although the difference between the two eyes is slight, when it is transmitted to the brain through retinas, the brain has a sense of different distances based on the slight difference, thereby generating the stereoscopic sense. One eye can also see the object, but it is difficult to differentiate the farness and nearness and the distance of the object. According to this principle, for the same image, if two pictures with a slight angle difference are produced or shot by using the viewing angle difference of the two eyes, and then the two human eyes are made to respectively view the two pictures, the brain generates a stereoscopic image through the retinas. Currently, the principle is applied to various stereoscopic image demonstration techniques. However, the conventional stereoscopic image viewing devices have some disadvantages, for example, the technique is complicated, the cost is high, the image viewing effect is not ideal, so it is difficult to popularize and use the stereoscopic image viewing device as a personal product.

As the electronic technology is developed, a multi-functional electronic product with communication, shooting, recording, displaying, and gaming functions is proposed, for example, a newly proposed portable game console Gizmondo Widescreen having a mobile phone function, which is a revolution to the conventional electronic product. However, most of the electronic video products can display only plane images, and few personal electronic devices through which the eyes may view high-quality stereoscopic images are available. A terminal device having functions of stereoscopic shoot, gaming, communication, projection, business card recognition, global positioning system (GPS) positioning and navigation, plane and stereoscopic display is not available. According to a naked eye stereoscopic image liquid crystal display (LCD) proposed by SHARP in 2004, the inventor of the application designs a new personal stereoscopic video multimedia electronic device.

### SUMMARY OF THE INVENTION

The present invention is directed to a portable integrative stereoscopic video multimedia device, which has a simple structure and a vivid stereoscopic effect, is convenient to use, is suitable for personal use, and enables a user to store and view images immediately after the images are shot.

The present invention provides a portable integrative stereoscopic video multimedia device, which includes two digital camera modules 2, an adjusting device 4 for adjusting an axle distance and included angle between the digital camera modules, a naked eye stereoscopic image LCD 5, one or two optical projection systems 6, a projection control and image signal driver 7, sound pickups 8, loudspeakers 9, a memory 10, signal interfaces 11, a plurality of analog/digital converters 12, 2D/3D signal converters 13, a processor 14, a power source 30, process control software, and a body 15.

The two digital camera modules 2 are used to shoot two image signals having a viewing angle difference.

The adjusting device 4 for adjusting an axle distance and included angle between the digital camera modules is used to install and adjust the axle distance and the included angle between the two digital camera modules.

The naked eye stereoscopic image LCD 5 is used to display images.

The one or two optical projection systems 6 are used to project and display the images.

The projection control and image signal driver 7 is used to control the optical projection systems.

The sound pickups 8 are used to pick up audio signals.

The loudspeakers 9 are used to play the audio signals.

The memory 10 is used to store electrical signals.

The signal interfaces 11 are used to realize an exchange with external signals.

The plurality of analog/digital converters 12 is correspondingly connected to the digital camera modules 2, the naked eye stereoscopic image LCD 5, the optical projection systems 6, the projection control and image signal driver 7, the sound pickups 8, the loudspeakers 9, the memory 10, and the signal interfaces 11, and is used to convert the shot image signals, the picked audio signals, the electrical signals input or output from the signal interfaces, or the stored signals to analog/digital or digital/analog signals.

The 2D/3D signal converters 13 are used to convert a 2D signal to a 3D signal, or convert a 3D signal to a 2D signal.

The processor 14 is respectively connected to the plurality of analog/digital converters 12, and is used to process the digital signals from the analog/digital converters 12, display the images through the naked eye stereoscopic image LCD 5 and the optical projection systems 6, and store the digital signals processed by the processor 14 in the memory 10.

The power source 30 is used to supply power for the portable integrative stereoscopic video multimedia device.

The process control software is used to coordinate the two digital camera modules 2, the adjusting device 4 for adjusting an axle distance and included angle between the digital camera modules, the naked eye stereoscopic image LCD 5, the sound pickups 8, the loudspeakers 9, the memory 10, the signal interfaces 11, the analog/digital converters 12, the 2D/3D signal converters 13, and the processor 14 for shooting the images, process and store the shot image signals, process the external signals exchanged by the signal interfaces, process the picked audio signals and the played audio signals, process the optical projection system 6, the projection control and image signal driver 7, the loudspeakers 9, the memory 10, the signal interfaces 11, the analog/digital converters 12, and the 2D/3D signal converters 13 for projecting the images, and perform view finding and image viewing by using the naked eye stereoscopic image LCD 5.

The body 15 is used accommodate the elements, so as to form the portable integrative stereoscopic video multimedia device.

In the portable integrative stereoscopic video multimedia device, the two digital camera modules 2 include a left camera 200 and a right camera 201. The left camera 200 and the right camera 201 are disposed on the adjusting device 4 for adjusting the axle distance and included angle between the digital camera modules. The left camera 200 and the right camera 201 are respectively movably mounted on a left slide base 400 and a right slide base 401 of the adjusting device 4 for adjusting an axle distance and included angle between the digital camera modules. The left slide base 400 and the right slide base 401 are disposed on a straight guide rail 402 in the body 15 at an interval distance. In order to adjust the axle distance between the two camera modules, a moving mechanism 403 matching the left slide base 400 and the right slide base 401 is disposed. A left screw hole 4043 is disposed on the left slide base 400, a left driving screw 4031 matching the left screw hole 4043 controls an operation of a moving motor 4030, so as to adjust a distance between the left camera 200 and the right camera 201. A left rotating mechanism 404 and a right rotating mechanism 405 are respectively disposed on the left camera 200 and the right camera 201. The left rotating mechanism 404 is composed of a micro motor 4040 and a driving gear 4041 mounted on a power output shaft of the micro motor 4040. A left driving tooth 4042 is disposed on an edge of the left slide base 400. The driving gear 4041 is engaged with the left driving tooth 4042, and the micro motor 4040 controls an angle adjustment of the left camera 200, so as to adjust the included angle between axial lines of the left camera 200 and the right camera 201. Similarly, operations of the moving mechanism and the right rotating mechanism of the right camera 201 are the same as that of the left rotating mechanism.

A linkage control knob 406 of the moving mechanism 403, the left rotating mechanism 404, and the right rotating mechanism 405 is disposed on the body 15.

The process control software further includes software for coordinating the two digital camera modules 2 and the adjusting device 4 for adjusting an axle distance and included angle between the digital camera modules, so as to synchronously control the two digital camera modules to perform view finding, tracking, and automatic focusing of a shooting target.

The portable integrative stereoscopic video multimedia device further includes a binocular stereoscopic viewing module 3 for performing the view finding and playing and viewing stereoscopic images.

The portable integrative stereoscopic video multimedia device further includes a game unit 16, having a wireless data transmission function. The game unit 16 forms a circuit connection with the naked eye stereoscopic image LCD 5, the sound pickups 8, the loudspeakers 9, the memory 10, the signal interfaces 11, the analog/digital converters 12, the 2D/3D signal converters 13, and the processor 14. Game operation buttons 160 are disposed on the body 15. The process control software further includes software for controlling games, displaying the games, and projecting images.

The portable integrative stereoscopic video multimedia device further includes a wireless mobile communication unit 17 having a radio receiving function. The wireless mobile communication unit 17 forms a circuit connection with the naked eye stereoscopic image LCD 5, the sound pickups 8, the loudspeakers 9, the memory 10, the signal interfaces 11, the analog/digital converters 12, the 2D/3D signal converters 13, and the processor 14. Communication keys 170 are disposed on the body 15. The process control software further includes software for operating the wireless mobile communication unit 17 having the radio receiving function, displaying unit images, and performing communication.

The portable integrative stereoscopic video multimedia device further includes a global positioning system (GPS) unit 18. The GPS unit 18 forms a circuit connection with the naked eye stereoscopic image LCD 5, the sound pickups 8, the loudspeakers 9, the memory 10, the signal interfaces 11, the analog/digital converters 12, the 2D/3D signal converters 13, and the processor 14. A navigation key 180 is disposed on the body 15. The process control software further includes software for operating the GPS unit 18 and displaying positioning and navigation data.

The portable integrative stereoscopic video multimedia device further includes a business card recognition unit 19. The business card recognition unit 19 forms a circuit connection with the two digital camera modules 2, the naked eye stereoscopic image LCD 5, the memory 10, the signal interfaces 11, the analog/digital converters 12, the 2D/3D signal converters 13, and the processor 14. A business card recognition key 190 is disposed on the body 15. The process control software further includes software for controlling the business card recognition unit 19, storing the data, displaying the data, and exchanging the data with the signal interfaces 1.

In the portable integrative stereoscopic video multimedia device, the signal interfaces 11 include one or more of an analog signal interface, a digital signal interface, an infrared interface, a Bluetooth interface, a wireless fidelity (WiFi) interface, and an Ethernet interface. The process control software further includes software for matching the interfaces.

The portable integrative stereoscopic video multimedia device further includes a fill light 20, and the process control software further includes software for coordinating the two digital camera modules 2, the adjusting device 4 for adjusting an axle distance and included angle between the digital camera modules, and the fill light 20, so as to supplement light when shooting with the two digital camera modules.

In the portable integrative stereoscopic video multimedia device, the memory 10 includes a memory expansion slot 100.

In the present invention, through the above structure, a user may view stereoscopic images displayed on the display or projected plane images with naked eyes. The present invention has advantages of a simple structure and a vivid stereoscopic effect of the shot and viewed display images. After further modification, the present invention may be used for shooting, storing, and viewing images, and may form a multi-functional personal electronic device with a mobile communication unit, an entertainment unit, and a projection unit.

### BRIEF DESCRIPTION OF THE DRAWINGS

The present invention will become more fully understood from the detailed description given herein below for illustration only, and thus are not limitative of the present invention, and wherein:

FIG. 1 is a schematic three-dimensional structural front view of an embodiment of the present invention;

FIG. 2 is a schematic three-dimensional structural back view of an embodiment of the present invention;

FIG. 3 is a circuit block diagram of the principle of the present invention;

FIG. 4 is a schematic view of the principle of an adjusting device for adjusting an axle distance and included angle between digital camera modules of the present invention; and

FIG. 5 is a partial cross-sectional view taken along A-A of FIG. 4.

### DETAILED DESCRIPTION OF THE INVENTION

In the present invention, functions of stereoscopic shooting, gaming, communication, projection, business card recognition, GPS positioning and navigation, plane display, and stereoscopic display are integrated, and the function of each element is fully utilized and is shared with one another through software. Therefore, both the functions and the cost are considered to the maximum extent. A detailed description of the present invention is given below with reference to the accompanying drawings.

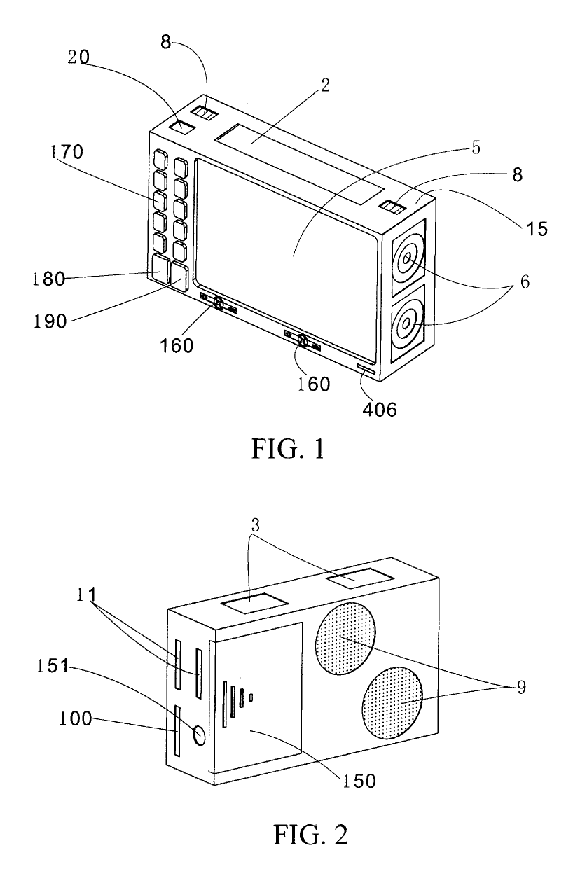

As shown in FIGS. 1 and 2, in the present invention, the functions of stereoscopic shooting, gaming, communication, projection, business card recognition, GPS positioning and navigation, plane display, and stereoscopic display are integrated. A naked eye stereoscopic image LCD 5, a linkage control knob 406, game operation buttons 160, communication keys 170, a navigation key 180, a business card recognition key 190 are disposed on a front side of the body 15. Loudspeakers 9 and a battery cover 150 are disposed on a back side of the body 15. Digital camera modules 2, sound pickups 8, and a fill light 20 are disposed on an upper side of the body 15. A binocular stereoscopic viewing module 3 is disposed on a lower side of the body 15. Signal interfaces 11, a memory expansion slot 100, and an external power jack 151 are disposed on a right side of the body 15. Loudspeakers 9 may be speakers or earphones. In order to generate a stereoscopic effect, two or more loudspeakers 9 may be used.

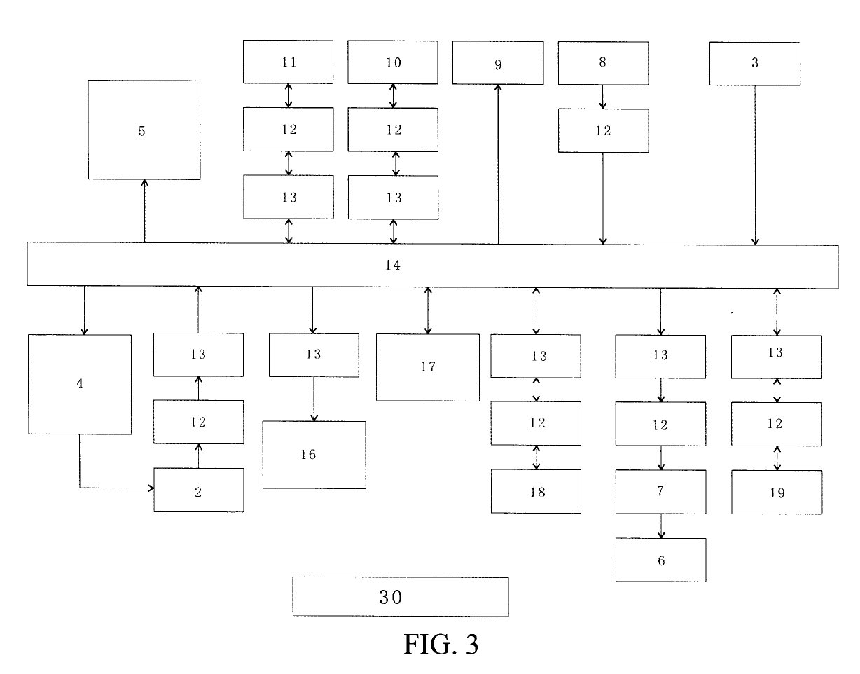

As shown in FIG. 3, a master control member of the present invention is a processor 14, which forms a circuit connection with a power source, two digital camera modules 2, an adjusting device 4 for adjusting an axle distance and included angle between the digital camera modules, the naked eye stereoscopic image LCD 5, the binocular stereoscopic viewing module 3, an optical projection system 6, a projection control and image signal driver 7, the sound pickups 8, the loudspeakers 9, the memory 10, the signal interfaces 11, a plurality of analog/digital converters 12, a game unit 16, a wireless mobile communication unit having a radio receiving function 17, a GPS unit 18, and a business card recognition unit 19, and controls and coordinates the above elements as follows.

Shooting and viewing shot images: the linkage control knob 406 is operated, under an instruction of the control software of the adjusting device 4 for adjusting an axle distance and included angle between the digital camera modules, the two digital camera modules 2 automatically focus and respectively shoot the images through the view finding device 3. The digital camera modules respectively convert analog image signals to digital image signals through the analog/digital converters, and the digital image signals are stored in the memory 10. Similarly, audio signals obtained by the sound pickups 8 are converted to digital audio signals through the analog/digital converters, and the digital audio signals are stored in the memory 10. According to demands, two methods for viewing stereoscopic programs (3D) or plane programs (2D) as follows are provided. For the playing of the stereoscopic programs, the digital image signals stored in the memory 10 and from different camera modules are converted to 3D signals through 2D/3D digital converters, and the 3D signals are stored in the memory. During playing, the 3D signals and the digital audio signals in the memory are respectively played through the naked eye stereoscopic image LCD 5 or the binocular stereoscopic viewing module 3 and the loudspeakers 9. For the playing of the plane programs, 2D digital image signals and the digital audio signals stored in the memory 10 are respectively played through the loudspeakers 9, the projection control and image signal driver 7, the optical projection system 6, or the binocular stereoscopic viewing module 3.

Shooting and viewing external signals: the analog image signals and the analog audio signals are input through the signal interfaces 11 and stored in the memory 10, the analog image signals and the analog audio signals are converted to the digital image signals and the digital audio signals through the analog/digital converter converts, and the digital image signals and the digital audio signals are stored in the memory 10. For the playing of the stereoscopic programs, the 2D digital image signals stored in the memory 10 are converted to the 3D signals through the 2D/3D digital converters, and the 3D signals are stored in the memory. During playing, the 3D signals and the digital audio signals in the memory are respectively played through the naked eye stereoscopic image LCD 5 or the binocular stereoscopic viewing module 3 and the loudspeakers 9. For the playing of the plane programs, the 2D digital image signals and the digital audio signals stored in the memory 10 are respectively played through the loudspeakers 9, and the projection control and image signal driver 7, the optical projection system 6 or the binocular stereoscopic viewing module 3.

If the signals input from the signal interfaces 11 are the digital signals, the digital image signals and the digital audio signals are stored in the memory 10. For the playing of the stereoscopic programs, the 2D digital image signals stored in the memory 10 are converted to the 3D signals through the 2D/3D digital converters, and the 3D signals are stored in the memory. During playing, the 3D signals and the digital audio signals in the memory are respectively played through the naked eye stereoscopic image LCD 5 or the binocular stereoscopic viewing module 3, and the loudspeakers 9. For the playing of the plane programs, the 2D digital image signals and the digital audio signals stored in the memory 10 are respectively played through the loudspeakers 9, and the projection control and image signal driver 7, the optical projection system 6, or the binocular stereoscopic viewing module 3.

If the signals input from the signal interfaces 11 are the 3D digital signals, the 3D digital signals are stored in the memory. For the playing of the stereoscopic programs, the 3D signals and the digital audio signals in the memory are respectively played through the naked eye stereoscopic image LCD 5, or the binocular stereoscopic viewing module 3, and the loudspeakers 9. For the playing of the plane programs, the 3D digital image signals stored in the memory 10 are converted to the 2D signals through the 2D/3D digital converters, and the 2D signals are stored in the memory. During playing, the 2D signals and the digital audio signals in the memory are respectively played through the loudspeakers 9, and the projection control and image signal driver 7, the optical projection system 6, or the binocular stereoscopic viewing module 3.

Structure of the game unit 16: the game unit 16 may be a game unit having a wireless data transmission function. The game unit 16 forms the circuit connection with the naked eye stereoscopic image LCD 5 or the binocular stereoscopic viewing module 3, the sound pickups 8, the loudspeakers 9, the memory 10, the signal interfaces 11, the analog/digital converters 12, the 2D/3D signal converters 13, and the processor 14. Under the control of the software for controlling the games, displaying the games, and projecting the display images, digital image signals and digital audio signals of game programs input from the signal interfaces 11 are stored in the memory 10. For the playing of the stereoscopic programs, 2D game digital image signals stored in the memory 10 are converted to the 3D signals through the 2D/3D digital converters, and the 3D signals are stored in the memory. During playing, the 3D signals and the digital audio signal in the memory are respectively played through the naked eye stereoscopic image LCD 5, or the binocular stereoscopic viewing module 3, and the loudspeakers 9. For the playing of the plane programs, the 2D game digital image signals and the digital audio signals stored in the memory 10 are respectively played through the loudspeakers 9, the projection control and image signal driver 7, and the optical projection system 6. The game operation buttons 160 disposed on the body 15 are used to operate the game.

Structure of the wireless mobile communication unit having the radio receiving function 17: the wireless mobile communication unit forms the circuit connection with the naked eye stereoscopic image LCD 5 or the binocular stereoscopic viewing module 3, the sound pickups 8, the loudspeakers 9, the memory 10, the signal interfaces 11, the analog/digital converters 12, the 2D/3D signal converters 13, and the processor 14. Under the control of the software for operating the wireless mobile communication unit having the radio receiving function 17, displaying the unit images, and performing the communication, communication keys 170 disposed on the body 15 are operated, so as to realize the communication. For the displaying of communication signals, digital communication signals are stored in the memory 10, and the digital communication signals are converted to the 3D signals through the 2D/3D digital converters, and then the 3D signals are displayed through the naked eye stereoscopic image LCD 5 or the binocular stereoscopic viewing module 3.

Structure of the GPS unit 18: the GPS unit 18 forms the circuit connection with the naked eye stereoscopic image LCD 5 or the binocular stereoscopic viewing module 3, the sound pickups 8, the loudspeakers 9, the memory 10, the signal interfaces 1, the analog/digital converters 12, the 2D/3D signal converters 13, and the processor 14. Under the software for operating the GPS unit 18 and displaying positioning and navigation data, the GPS positioning and navigation functions are realized.

Structure of the business card recognition unit 19: the business card recognition unit 19 forms the circuit connection with the two digital camera modules 2, the naked eye stereoscopic image LCD 5, the binocular stereoscopic viewing module 3, the memory 10, the signal interfaces 11, the analog/digital converters 12, the 2D/3D signal converters 13, and the processor 14. The business card recognition key 190 on the operate body 15 is operated. Under the control of the business card recognition software, business card data is read by the digital camera modules and is stored in the memory, the analog image signals are converted to the digital signals through the analog/digital converters, and the digital signals are stored in the memory. During viewing, the 2D digital image signals stored in the memory are converted to the 3D signals through the 2D/3D digital converters, and the 3D signals are stored in the memory. During viewing, the 3D signals in the memory are displayed through the naked eye stereoscopic image LCD 5 or the binocular stereoscopic viewing module 3. The signal interfaces may also be used to exchange the information with other devices, or the wireless mobile communication unit having the radio receiving function 17 is used to transmit picture information.

The signal interfaces 11 of the present invention may be one or more of an analog signal interface, a digital signal interface, an infrared interface, a Bluetooth interface, a WiFi interface, and an Ethernet interface. The memory 10 of the present invention includes a program memory, an address memory, and a buffer. The signal interfaces, the memory, and the analog/digital converters of the present invention may be shared.

The power source 30 of the present invention may be one of or both of a built-in and an external power source.

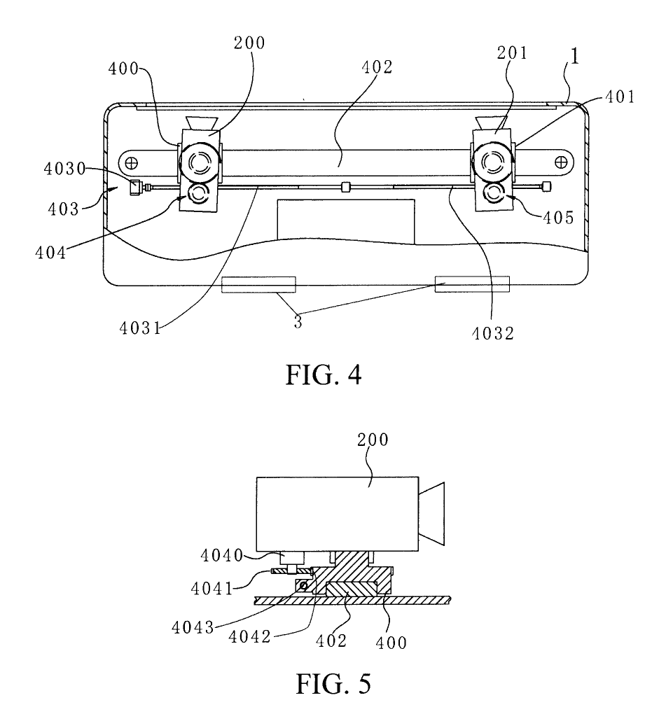

FIGS. 4 and 5 are schematic views of the principle of the structure of the adjusting device 4 for adjusting an axle distance and included angle between the digital camera modules of the present invention. Referring to FIGS. 4 and 5, the digital camera modules 2 include a left camera 200 and a right camera 201. The left camera 200 and the right camera 201 are disposed on the adjusting device 4 for adjusting the axle distance and included angle between the digital camera modules, and the focal length is controlled and adjusted by the process control software. The left camera 200 and the right camera 201 are respectively mounted on a left slide base 400 and a right slide base 401 of the adjusting device 4 for adjusting an axle distance and included angle between the digital camera modules. The left slide base 400 and the right slide base 401 are disposed on a straight guide rail 402 in the body 15 at an interval. In order to adjust the axle distance between the two camera modules, a moving mechanism 403 matching the left slide base 400 and the right slide base 401 is disposed. A left rotating mechanism 404 and a right rotating mechanism 405 are respectively disposed on the left camera 200 and the right camera 201.

The mechanism moving mechanism 403 of the adjusting device 4 for adjusting an axle distance and included angle between the digital camera modules includes a moving motor 4030, a left driving screw 4031, and a right driving screw 4032. An output shaft of the moving motor 4030 is jointed to the left driving screw 4031 and the right driving screw 4032. The left driving screw 4031 has a right-hand thread, and the right driving screw 4032 has a left-hand thread. The left driving screw 4031 and the right driving screw 4032 are respectively connected to the left slide base 400 and the right slide base 401 through the right-hand thread and the left-hand thread. The left rotating mechanism 404 is composed of a micro motor 4040 and a driving gear 4041 mounted on a power output shaft of the micro motor 4040. A left driving tooth 4042 is disposed on an edge of the left slide base 400. The driving gear 4041 is engaged with the left driving tooth 4042, and the micro motor 4040 controls and adjusts an angle of the left camera 200, so as to adjust an included angle between axial lines of the left camera 200 and the right camera 201, and to control the left slide base 400 to move on the straight guide rail 402. A left screw hole 4043 is disposed on the left slide base 400, and the left driving screw 4031 matching the left screw hole 4043 controls the operation of the moving motor 4030, so as to adjust the distance between the left camera 200 and the right camera 201. Similarly, operations of the moving mechanism and the right rotating mechanism of the right camera 201 are the same as those of the left rotating mechanism.

In the present invention, one or two projection lenses may be used, and the operating principles of the stereoscopic images are respectively as follows.

For one projection lens, a time difference principle is utilized. During projection, the two left and right image signals are alternately played. During viewing, a synchronous LCD switching spectacle is worn, such that the left and the right eyes respectively view the two image frames with the visual difference, so as to achieve the stereoscopic image effect through the human brain.

For two projection lenses, a polarized light principle is utilized. During the projection, the two left and right image signals are simultaneously played in different light wave vibration directions, and are projected to a screen capable of maintaining the original light wave vibration directions after reflection. During viewing, a polarized light spectacle is worn, such that the left and the right eyes respectively view the two image frames with the visual difference, so as to achieve the stereoscopic image effect through the human brain.

In addition to the optical projection system and the projection control and image signal driver, in order to meet the requirements for different display functions and satisfy different demands of people, the naked eye stereoscopic image LCD 5 and the binocular stereoscopic viewing module 3 are disposed in the display part of the present invention.

What is claimed is:

1. A portable integrative stereoscopic video multimedia device, comprising:
two digital camera modules (2), for shooting two image signals having a viewing angle difference;
an adjusting device (4) for adjusting an axle distance and an included angle between the digital camera modules, for mounting the digital camera modules and adjusting the axle distance and the included angle between the two digital camera modules;
a naked eye stereoscopic image liquid crystal display (LCD) (5), for displaying images;
one or two optical projection systems (6), for projecting and displaying the images;
a projection control and image signal driver (7), for controlling the optical projection systems;
sound pickups (8), for picking up audio signals;
loudspeakers (9), for playing the audio signals;
a memory (10), for storing electrical signals;
signal interfaces (11), for realizing an exchange with external signals;
a plurality of analog/digital converters (12), correspondingly connected to the digital camera modules (2), the naked eye stereoscopic image LCD (5), the optical projection systems (6), the projection control and image signal driver (7), the sound pickups (8), the loudspeakers (9), the memory (10), and the signal interfaces (11), and converting the shot image signals, the picked audio signals, the electrical signals input or output from the signal interfaces, or the stored signals to analog/digital or digital/analog signals;
2D/3D signal converters (13), for converting a 2D signal to a 3D signal, or converting a 3D signal to a 2D signal;
a power source (30), for supplying power for the portable integrative stereoscopic video multimedia device;
a processor (14), respectively connected to the plurality of analog/digital converters (12), for processing the digital signals from the analog/digital converters (12), displaying the images through the naked eye stereoscopic image LCD (5) and the optical projection systems (6), and storing the digital signals processed by the processor (14) in the memory (10);
a process control software, for coordinating the two digital camera modules (2), the adjusting device (4) for adjusting the axle distance and the included angle between the digital camera modules, the naked eye stereoscopic image LCD (5), the sound pickups (8), the loudspeakers (9), the memory (10), the signal interfaces (11), the analog/digital converters (12), the 2D/3D signal converters (13), and the processor (14), so as to shoot the images; processing and storing the shot image signals; processing the external signals exchanged by the signal interfaces; processing the picked audio signals and the played audio signals; processing the optical projection system (6), the projection control and image signal driver (7), the loudspeakers (9), the memory (10), the signal interfaces (11), the analog/digital converters (12), and the 2D/3D signal converters (13), so as to project the images; and performing view finding and image viewing by using the naked eye stereoscopic image LCD (5); and
a body (15), for accommodating the above elements, so as to form the portable integrative stereoscopic video multimedia device.

2. The portable integrative stereoscopic video multimedia device according to claim 1, wherein the two digital camera modules (2) comprise a left camera (200) and a right camera (201); the left camera (200) and the right camera (201) are disposed on the adjusting device (4) for adjusting the axle distance and the included angle between the digital camera modules; the left camera (200) and the right camera (201) are respectively movably mounted on a left slide base (400) and a right slide base (401) of the adjusting device (4) for adjusting the axle distance and the included angle between the digital camera modules, the left slide base (400) and the right slide base (401) are disposed on a straight guide rail (402) in the body (15) at an interval; in order to adjust the axle distance between the two camera modules, a moving mechanism (403) matching the left slide base (400) and the right slide base (401) is disposed; a left screw hole (4043) is disposed on the left slide base (400), and a left driving screw (4031) matching the left screw hole (4043) controls an operation of a moving motor (4030), so as to adjust a distance between the left camera (200) and the right camera (201); a left rotating mechanism (404) and a right rotating mechanism (405) are respectively disposed on the left camera (200) and the right camera (201); the left rotating mechanism (404) comprises a micro motor (4040) and a driving gear (4041) mounted on a power output shaft of the micro motor (4040); a left driving tooth (4042) is disposed on an edge of the left slide base (400); the driving gear (4041) is engaged with the left driving tooth (4042), and the micro motor (4040) controls and adjusts an angle of the left camera (200), so as to adjust the included angle between axial lines of the left camera (200) and the right camera (201); similarly, operations of the moving mechanism and the right rotating mechanism of the right camera (201) are the same as the operations of the left rotating mechanism;
a linkage control knob (406) of the moving mechanism (403), the left rotating mechanism (404), and the right rotating mechanism (405) is disposed on the body (15); and
the process control software further comprises a software for coordinating the two digital camera modules (2) and the adjusting device (4) for adjusting the axle distance and the included angle between the digital camera modules, so as to synchronously control the two digital camera modules, and perform the view finding, tracking, and automatic focusing of a shooting target.

3. The portable integrative stereoscopic video multimedia device according to claim 1, further comprising a binocular stereoscopic viewing module (3), for performing the view finding and playing and viewing stereoscopic images.

4. The portable integrative stereoscopic video multimedia device according to claim 2, further comprising a binocular stereoscopic viewing module (3), for performing the view finding and playing and viewing stereoscopic images.

5. The portable integrative stereoscopic video multimedia device according to claim 1, further comprising a game unit (16), wherein the game unit (16) is a game unit having a wireless data transmission function; the game unit (16) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); game operation buttons (160) are disposed on the body (15); and the process control software further comprises a software for controlling games, displaying the games, and projecting the images.

6. The portable integrative stereoscopic video multimedia device according to claim 2, further comprising a game unit (16), wherein the game unit (16) is a game unit having a wireless data transmission function; the game unit (16) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); game operation buttons (160) are disposed on the body (15); and the process control software further comprises a software for controlling games, displaying the games, and projecting the images.

7. The portable integrative stereoscopic video multimedia device according to claim 1, further comprising a wireless mobile communication unit (17) having a radio receiving function, wherein the wireless mobile communication unit (17) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); communication keys (170) are disposed on the body (15); the process control software further comprises a software for operating the wireless mobile communication unit (17) having the radio receiving function, displaying the unit images, and performing communication.

8. The portable integrative stereoscopic video multimedia device according to claim 2, further comprising a wireless mobile communication unit (17) having a radio receiving function, wherein the wireless mobile communication unit (17) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); communication keys (170) are disposed on the body (15); the process control software further comprises a software for operating the wireless mobile communication unit (17) having the radio receiving function, displaying the unit images, and performing communication.

9. The portable integrative stereoscopic video multimedia device according to claim 1, further comprising a global positioning system (GPS) unit (18), wherein the GPS unit (18) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); a navigation key (180) is disposed on the body (15); and the process control software further comprises a software for operating the GPS unit (18), and displaying positioning and navigation data.

10. The portable integrative stereoscopic video multimedia device according to claim 2, further comprising a global positioning system (GPS) unit (18), wherein the GPS unit (18) forms a circuit connection with the naked eye stereoscopic image LCD (5), the sound pickups (8), the loudspeakers (9), the memory (10), the signal interfaces (11), the analog/digital converters (12), the 2D/3D signal converters (13), and the processor (14); a navigation key (180) is disposed on the body (15); and the process control software further comprises a software for operating the GPS unit (18), and displaying positioning and navigation data.

11. The portable integrative stereoscopic video multimedia device according to claim 1, further comprising a business card recognition unit (19), wherein the business card recognition unit (19) forms a circuit connection with the two digital camera modules (2), the naked eye stereoscopic image LCD (5), the memory (10), the signal interfaces (11), the analog/digital converters (12), the 2D/3D signal converters (13), and the processor (14); a business card recognition key (190) is disposed on the body (15); and the process control software further comprises a software for controlling the business card recognition unit (19), storing data, displaying the data, and exchanging the data with the signal interfaces (11).

12. The portable integrative stereoscopic video multimedia device according to claim 2, further comprising a business card recognition unit (19), wherein the business card recognition unit (19) forms a circuit connection with the two digital camera modules (2), the naked eye stereoscopic image LCD (5), the memory (10), the signal interfaces (11), the analog/digital converters (12), the 2D/3D signal converters (13), and the processor (14); a business card recognition key (190) is disposed on the body (15); and the process control software further comprises a software for controlling the business card recognition unit (19), storing data, displaying the data, and exchanging the data with the signal interfaces (11).

13. The portable integrative stereoscopic video multimedia device according to claim 1, wherein the signal interfaces (11) comprise one or more of an analog signal interface, a digital signal interface, an infrared interface, a Bluetooth interface, a wireless fidelity (WiFi) interface, and an Ethernet interface, and the process control software further comprises a software for matching the interfaces.

14. The portable integrative stereoscopic video multimedia device according to claim 2, wherein the signal interfaces (11) comprise one or more of an analog signal interface, a digital signal interface, an infrared interface, a Bluetooth interface, a wireless fidelity (WiFi) interface, and an Ethernet interface, and the process control software further comprises a software for matching the interfaces.

15. The portable integrative stereoscopic video multimedia device according to claim 1, further comprising a fill light (20), wherein the process control software further comprises a software for coordinating the two digital camera modules (2), the adjusting device (4) for adjusting the axle distance and the included angle between the digital camera modules, and the fill light (20), so as to supplement light during shooting with the two digital camera modules.

16. The portable integrative stereoscopic video multimedia device according to claim 2, further comprising a fill light (20), wherein the process control software further comprises a software for coordinating the two digital camera modules (2), the adjusting device (4) for adjusting the axle distance and the included angle between the digital camera modules, and the fill light (20), so as to supplement light during shooting with the two digital camera modules.

17. The portable integrative stereoscopic video multimedia device according to claim 1, wherein the memory (10) comprises a memory expansion slot (100).

18. The portable integrative stereoscopic video multimedia device according to claim 2, wherein the memory (10) comprises a memory expansion slot (100).
